(19) United States
(12) Patent Application Publication
(10) Pub. No.: US 2009/0102211 A1
(43) Pub. Date: Apr. 23, 2009

(54) Portable pet waste receptacle

(76) Inventor: Amir Antar, Los Angeles, CA (US)

Correspondence Address: JAMES RAY & ASSOCIATES, 2640 PITCAIRN ROAD, MONROEVILLE, PA, 15146, US

(21) Appl. No.: 12/283,085

(22) Filed: Sep. 9, 2008

Related U.S. Application Data
(60) Provisional application No. 60/981,819, filed on Oct. 22, 2007.

(51) Int. Cl. A01K 29/00

(52) U.S. Cl. 294/1.3

(57) ABSTRACT

A portable pet waste receptacle includes a frame member manufactured from a first predetermined material and having a first predetermined size and a first predetermined shape. A handle member is releasably securable to such frame member at a predetermined location thereon. Such handle member is manufactured from a second predetermined material and has a second predetermined size and a second predetermined shape. A securing mechanism has a first portion disposed on such handle member at a predetermined end thereof and a second portion disposed on such frame member at a predetermined location thereon for releasably securing such handle member to such frame member. A disposable receptacle member for receiving pet waste therein is releasably attached to such frame member. The disposable receptacle member is manufactured from a third predetermined material and has a third predetermined size and a third predetermined shape.

### CROSS REFERENCE TO RELATED APPLICATION

This patent application is related to and claims priority from U.S. Provisional Patent Application Ser. No. 60/981,819 filed Oct. 22, 2007.

### FIELD OF THE INVENTION

The present invention relates, in general, to devices for disposing of pet waste, and, more particularly, this invention relates to a device for disposing of pet waste, such as dog feces and the like, which are often eliminated during walking of such dog and therefore require immediate clean up.

### BACKGROUND OF THE INVENTION

Prior to the conception and development of the present invention, people have generally cleaned up after their pets by scooping animal waste into a plastic bag or utilizing some type of scoop tool. Unfortunately, this usually involves either stooping or bending to handle the waste, a disgusting task, or emptying and cleaning the scoop tool, a loathsome and repulsive chore. Therefore there exists a need for a device which enables a user to clean up pet waste without requiring such user to stoop or bend, scoop, clean a scooper, or come in close contact with pet waste.

### SUMMARY OF THE INVENTION

The present invention provides a portable pet waste receptacle. Such portable pet waste receptacle includes a frame member manufactured from a first predetermined material and having a first predetermined size and a first predetermined shape. A handle member is releasably securable to such frame member at a predetermined location thereon. Such handle member is manufactured from a second predetermined material and has a second predetermined size and a second predetermined shape. A securing means has a first portion disposed on such handle member at a predetermined end thereof and a second portion disposed on such frame member at a predetermined location thereon for releasably securing such handle member to such frame member. A disposable receptacle member for receiving pet waste therein is releasably attached to such frame member. The disposable receptacle member is manufactured from a third predetermined material and has a third predetermined size and a third predetermined shape.

### OBJECTS OF THE INVENTION

It is, therefore, one of the primary objects of the present invention to provide a portable pet waste receptacle which is lightweight and convenient and easy to use and which will enable a user to clean up pet waste without having to stoop, scoop, clean a scooping type tool, or come in contact with such pet waste.

Another object of the present invention is to provide a pet waste receptacle which is portable and will enable a user to clean up pet waste without coming in close contact with such pet waste.

Still another object of the present invention is to provide a pet waste receptacle which can be quickly and easily disassembled for storage and transportation.

Yet another object of the present invention is to provide a pet waste receptacle which utilizes a disposable plastic bag to receive pet waste as elimination is occurring.

An additional object of the present invention is to provide a pet waste receptacle which can be disassembled and transported in a purse or shoulder type bag.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which the device is capable of being disassembled for transportation and storage.

FIG. 3 is a partial perspective view of the invention according to one embodiment of the invention in which such disposable receptacle member is a bag type member having a drawstring attached thereto.

FIG. 4 is a partial perspective view of the invention according to one embodiment of the invention in which such frame member is depicted as having a plurality of apertures through which such leg members may be adjustably disposed and a plurality of apertures through which securing means may be disposed for securing such leg members in position as desired.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

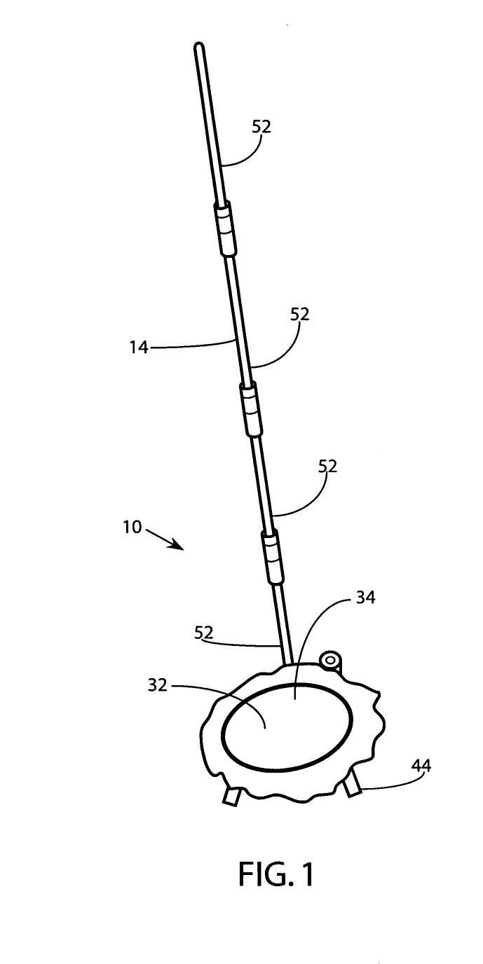

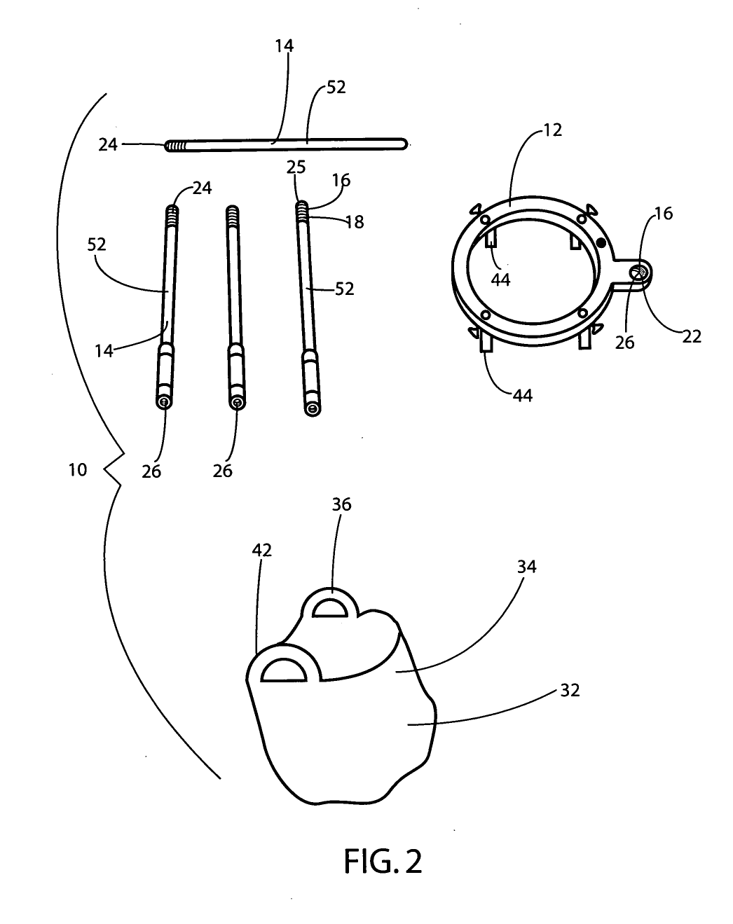

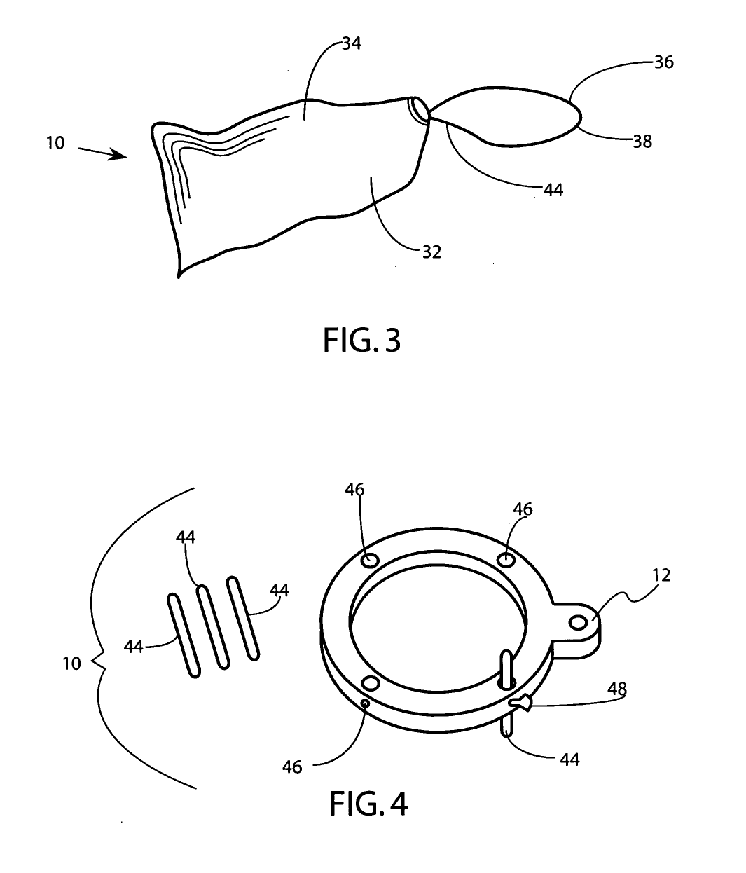

Reference is now made, more particularly, to FIGS. 1-4.

The present invention provides a portable pet waste receptacle, generally designated 10.

Such portable pet waste receptacle 10 includes a frame member 12 manufactured from a first predetermined material and having a first predetermined size and a first predetermined shape.

It is presently preferred that such first predetermined material is at least one of metal, plastic, and a combination thereof. It is presently most preferred that such first predetermined material is metal.

It is presently preferred that such first predetermined shape is at a least one of generally circular, generally square, generally rectangular, and generally oval. It is presently preferred that such first predetermined shape is generally circular.

A handle member 14 is releasably securable to such frame member 12 at a predetermined location thereon. Such handle member 14 is manufactured from a second predetermined material and has a second predetermined size and a second predetermined shape.

It is presently preferred that such handle member 14 includes a plurality of portions 52, each of such portions 52 having at least one of a threaded male portion 24 and a threaded female portion 26 for joining to at least one other of such plurality of portions 52. However, the device is not meant to be limited as such and such portions may be joined in any manner which reasonably facilitates such purpose including but not limited to a friction fit type joining of such portions and a telescoping type joining of such portions.

It is presently preferred that such second predetermined material is at least one of metal, plastic, and a combination thereof. It is presently most preferred that such second predetermined material is metal.

It is presently preferred that such first predetermined material and such second predetermined material are substantially identical.

A securing means 16 has a first portion 18 disposed on such handle member 14 at a predetermined end thereof and a second portion 22 disposed on such frame member 12 at a predetermined location thereon for releasably securing such handle member 14 to such frame member 12.

It is presently preferred that such first portion 18 of such securing means 16 is a threaded male portion 25 and such second portion 22 of such securing means 16 is a threaded female portion 26 such that such handle member 14 may be joined to such frame member 12 by screwing such threaded male portion 25 into such threaded female portion 26.

A disposable receptacle member 32 for receiving pet waste (not shown) therein is releasably attached to such frame member 12. The disposable receptacle member 32 is manufactured from a third predetermined material and has a third predetermined size and a third predetermined shape.

It is presently preferred that such third predetermined material is at least one of plastic, paper, cardboard, and a combination thereof. It is presently most preferred that such third predetermined material is plastic.

It is presently preferred that such disposable receptacle member 32 is a bag type member 34. As illustrated in FIG. 1 such bag type member 34 may be fitted at least one of over and within such frame member 12 thereby covering at least a portion of such frame member 12. It is meant that such user's pet will eliminate waste over and into such bag type member 34 such that the waste will be contained therein.

It is presently preferred that such bag type member 34 includes at least one of a carrying means 36, a closing means 38, and a combination thereof.

It is presently preferred that such at least one of such carrying means 36, such closing means 38, and such combination thereof includes at least one of handles 42, a drawstring 44, and a combination thereof. A user may then make use of such handles 42, drawstring 44, and such combination thereof to disengage such bag type member 34 from such frame member 12 and dispose of such bag type member 34 and the waste contained therein.

It is presently preferred that such frame member 12 further includes a plurality of leg members 44 releasably and adjustably attached thereto at predetermined locations thereon.

It is presently preferred that such frame member 12 includes a plurality of apertures 46 disposed therethrough, each of such apertures 46 being for receiving at least one of a leg member 44 and a securing means 48 for securing such leg member 44 in a predetermined position. As shown in FIG. 4, such leg members 44 may be slidably adjusted in such apertures 46 such that the device 10 sits a predetermined distance from the ground or flooring to accommodate pets of varying sizes. A screw, bolt, or friction fit type securing means may be implemented to facilitate securing such legs in the desired positions.

According to another embodiment, such leg members 44 are telescoping such that such leg members 44 are adjustable in length.

According to yet another embodiment such handle member 16 is telescoping such that such handle member 14 is adjustable in length.

It is further contemplated that such device 10 is capable of being disassembled or compacted such that such device 10 may be easily transported and stored. For example, such device 10, in its disassembled or compacted state, may even be capable of being transported in a purse or a small bag. However, the device 10 is not meant to be limited as such and may be easily transported and stored in its assembled state and in a partially assembled state as well.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A portable pet waste receptacle comprising:
a. a frame member being manufactured from a first predetermined material and having a first predetermined size and a first predetermined shape;
b. a handle member releasably securable to said frame member at a predetermined location thereon, said handle member being manufactured from a second predetermined material and having a second predetermined size and a second predetermined shape;
c. a securing means having a first portion disposed on said handle member at a predetermined end thereof and a second portion disposed on said frame member at a predetermined location thereon for releasably securing said handle member to said frame member; and
d. a disposable receptacle member for receiving pet waste therein releasably attached to said frame member, said disposable receptacle member being manufactured from a third predetermined material and having a third predetermined size and a third predetermined shape.

2. A portable pet waste receptacle according to claim 1 wherein said frame member further includes a plurality of leg members releasably and adjustably attached thereto at predetermined locations thereon.

3. A portable pet waste receptacle according to claim 2 wherein said frame member includes a plurality of apertures disposed therethrough each of said apertures being for receiving at least one of a leg member and a securing means for securing said leg member in a predetermined position.

4. A portable pet waste receptacle according to claim 2 wherein said leg members are telescoping such that said leg members are adjustable in length.

5. A portable pet waste receptacle according to claim 1 wherein said first predetermined shape is at a least one of generally circular, generally square, generally rectangular, and generally oval.

6. A portable pet waste receptacle according to claim 5 wherein said first predetermined shape is generally circular.

7. A portable pet waste receptacle according to claim 1 wherein said handle member is telescoping such that said handle member is adjustable in length.

8. A portable pet waste receptacle according to claim 1 wherein said handle member includes a plurality of portions, each of said portions having at least one of a threaded male portion and a threaded female portion for joining to at least one other of said plurality of portions.

9. A portable pet waste receptacle according to claim 1 wherein said first portion of said securing means is a threaded male portion and said second portion of said securing means is a threaded female portion such that said handle member may be joined to said frame member by screwing said threaded male portion into said threaded female opening.

10. A portable pet waste receptacle according to claim 1 wherein said first predetermined material is at least one of metal, plastic, and a combination thereof.

11. A portable pet waste receptacle according to claim 10 wherein said first predetermined material is metal.

12. A portable pet waste receptacle according to claim 1 wherein said second predetermined material is at least one of metal, plastic, and a combination thereof.

13. A portable pet waste receptacle according to claim 10 wherein said second predetermined material is metal.

14. A portable pet waste receptacle according to claim 13 wherein said first predetermined material and said second predetermined material are substantially identical.

15. A portable pet waste receptacle according to claim 1 wherein said disposable receptacle member is a bag type member.

16. A portable pet waste receptacle according to claim 15 wherein said bag type member includes at least one of a carrying means, a closing means, and a combination thereof.

17. A portable pet waster receptacle according to claim 16 wherein said at least one of said carrying means, said closing means, and said combination thereof includes at least one of handles, a drawstring, and a combination thereof.

18. A portable pet waste receptacle according to claim 1 wherein said third predetermined material is at least one of plastic, paper, cardboard, and a combination thereof.

19. A portable pet waste receptacle according to claim 18 wherein said third predetermined material is plastic.
